(19) United States
(12) Patent Application Publication
(10) Pub. No.: US 2004/0068330 A1
(43) Pub. Date: Apr. 8, 2004

(54) Methods and apparatus for remote programming of field programmable gate arrays

(75) Inventor: Daniel Frederick White, Lilburn, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation, Dayton, OH

(21) Appl. No.: 10/264,799

(22) Filed: Oct. 4, 2002

(51) Int. Cl. G05B 11/01; G06F 13/10; G06F 9/44

(52) U.S. Cl. 700/18; 717/171; 719/321; 719/327

(57) ABSTRACT

Techniques for remotely programming a field programmable gate array, or FPGA, are described. A field programmable gate array uses operating software which is stored in a memory such as a parallel flash memory. Upon power up or reset of the FPGA, the operating software is converted to serial form and loaded into the FPGA, where it is used to control the operations of the FPGA. When it is desired to update the operating software, an updated operating software package is transferred from a remote location to a terminal associated with the FPGA. The FPGA then retrieves the updated operating software from the terminal over a connection such as a universal serial bus (USB) connection and transfers it to the flash memory, overwriting the previously installed operating software. Upon a subsequent power up or reset of the FPGA, the updated operating software is loaded into the FPGA.

### FIELD OF THE INVENTION

The present invention relates generally to improvements in the remote programming of devices. More particularly, the invention relates to advantageous techniques for remotely programming a field programmable gate array.

### BACKGROUND OF THE INVENTION

Numerous hardware devices include embedded logic circuits, with programming included with the logic circuits. Exemplary devices include touch screen displays including logic circuits with programming governing the display of images and the interpretation of a touch, and keyboards including logic circuits with programming governing the identity of keys and the interpretation of keystrokes. Such onboard programming relieves processing load for a terminal with which the devices are used, and also increases the adaptability of the devices to different terminals. For example, a display may be able to be transferred to a terminal employing a different display system by reprogramming the logic circuit.

One useful and popular choice for an embedded logic circuit is a field programmable gate array (FPGA). A typical field programmable gate array resides with a read only memory (ROM) or programmable read only memory (PROM) on a circuit board. When power is applied to the circuit board, the programming information is serially loaded from the ROM or PROM, as the case may be, to the FPGA. Changes to programming are typically made by replacing the ROM or PROM on the circuit board. If a change to programming is required, for example an upgrade or discovery of a programming bug, substantial labor costs will be incurred if updated programming is to be provided to a large number of devices. In addition, a hardware cost will be incurred for the replacement ROMs or PROMS, and there will be a loss of use of each device while it is taken offline during the reprogramming. There exists, therefore, a need for techniques for programming field programmable gate arrays without a need to replace hardware in order to accomplish the programming and which minimize the time that a device must be kept offline in order to accomplish the reprogramming.

### SUMMARY OF THE INVENTION

A remotely programmable FPGA assembly according to an aspect of the present invention includes an FPGA, a flash memory and a complex programmable logic device (CPLD) assembled together, suitably on a single circuit board. The FPGA assembly also includes a remote access port such as a universal serial bus (USB) port for communication with external devices. The flash memory may suitably be a parallel flash memory. The flash memory provides an output to a CPLD, which in turn provides an output to the FPGA. The flash memory receives an input from the FPGA, and the FPGA is connected to the remote access port. When the FPGA is to be remotely programmed, programming information is supplied to the FPGA over the remote access port. The FPGA transfers the programming information to the flash memory. Once the transfer has been accomplished, the programming information remains available in the flash memory. Upon power up or reset of the circuit board, the flash memory transfers the programming information in parallel to the CPLD. The CPLD converts the parallel information to serial information and transfers it to the FPGA.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a retail center employing remotely programmable devices according to the present invention;

FIG. 2 illustrates a stage in the programming of a remotely programmable device according to the present invention;

FIG. 3 illustrates a further stage in the programming of a remotely programmable device according to the present invention; and

FIG. 4 illustrates a process of remote programming of a device according to the present invention.

### DETAILED DESCRIPTION

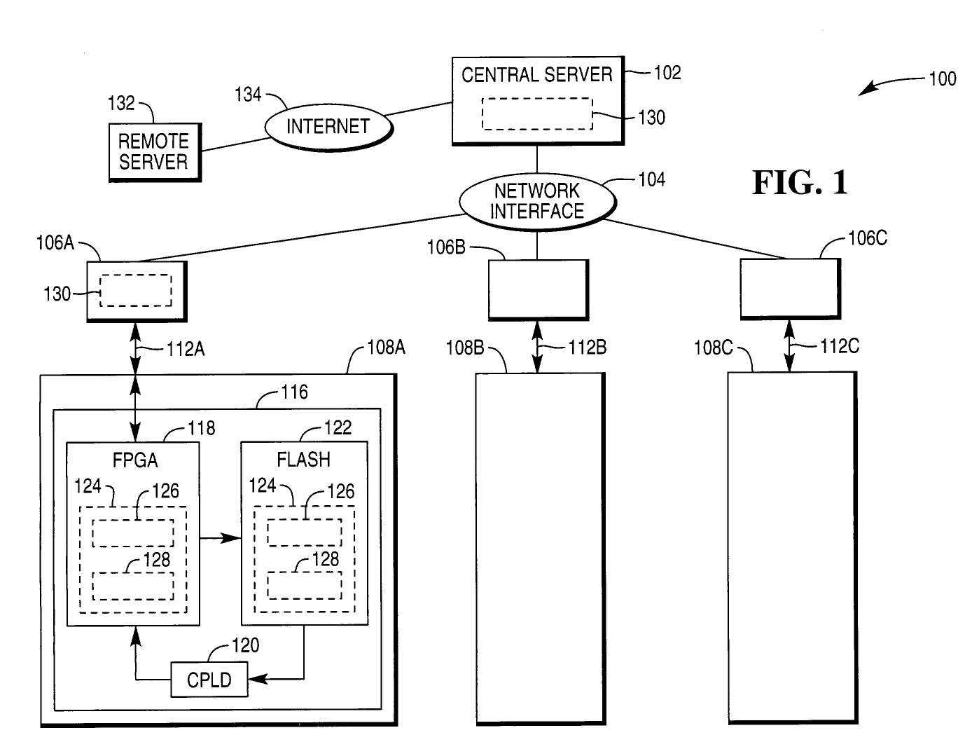

FIG. 1 illustrates a retail center 100 employing remotely reprogrammable devices according to an aspect of the present invention. The retail center 100 includes a central server 102, a network interface 104 and a plurality of terminals 106A-106C, communicating with the central server 102 through the network interface 104. The terminals 106A-106C may suitably be point of sale terminals including components such as computers, scanners, keyboards, displays and the like, used in processing retail transactions. For simplicity of illustration and description, most of the components of the terminals 106A-106C are not individually described, but it will be understood that the teachings of the present invention are adaptable for use with numerous different configurations for terminals such as the terminals 106A-106C, having numerous combinations of components. While three terminals are shown as illustrative, it will be recognized that more or fewer terminals may be employed.

The terminals 106A-106C include displays 108A-108C, respectively. The displays 108A-108C are connected to the terminals 106A-106C through USB connections 112A-112C. The display 108A includes an onboard controller 116, according to the present invention. The displays 108B and 108C include similar onboard controllers, but these are not shown in order to simplify illustration and description and to avoid redundancy. While displays are shown, it will be recognized that a retail center may employ one or more of a wide variety of programmable devices, such as keyboards, scanners and other devices may suitably employ controllers such as the onboard controller 116 and may suitably employ the techniques of the present invention for programming of such controllers.

The onboard controller 116 includes a field programmable gate array (FPGA) 118, a CPLD 120 and a parallel flash memory 122. The flash memory 122 is connected to the FPGA 118. The flash memory 122 receives information from the FPGA 118 as an input. The flash memory is also connected to the CPLD 120, which receives information from the flash memory 122 as an input. The CPLD 120 is connected to the FPGA 118, which receives information from the CPLD 120 as an input. The FPGA 118 is also connected to a USB interface port 124, which allows connection of the onboard controller 116 to the terminal 106A through the USB connection 112A. The onboard controller 116 may suitably include the FPGA 118, the CPLD 120 and the flash memory 122 on a single circuit board, with connections between the various components being provided by circuit board traces. It will be recognized that additional configurations may be achieved, for example implementation of the controller 116 as a single chip, with the FPGA 118, the CPLD 120 and the flash memory 122 being components of the chip.

The display 108A is connected to the terminal 106A through the connection of the onboard controller 116 to the terminal 106A. All commands and data transferred between the terminal 106A and the display 108A come through the onboard controller 116.

The exemplary onboard controller 116, and thus the exemplary display 108A, is connected to the terminal 106A through the USB connection 112A. It will be recognized, however, that a USB connection is not required, and that other connections may be used that will allow a desired rate of information transfer between the terminal 106A and the onboard controller 116.

The flash memory 122 hosts an operating software package 124, including a USB communication control module 126 and a data transfer module 128. Whenever the onboard controller 116 is powered up or reset, the operating software package 124 is transferred in parallel from the flash memory 122 to the CPLD 120, which performs a parallel to serial conversion and serially transfers the operating software package 124 to the FPGA 118. The FPGA 118 then proceeds to operate under the control of the operating software package 124.

When it is desired to reprogram the onboard controller 116 with corrected or upgraded software, an updated operating software package 130 is stored in or transferred to the terminal 106A for copying to the onboard controller 116. Typically, and as illustrated here, the updated operating software package is retrieved from the central server 102, although it will be recognized that the updated operating software package may be transferred to the terminal 106A in other ways, for example, by copying from a CD-ROM or floppy disk. In the more typical case, and as illustrated here, the operating software package 124 may suitably be downloaded from a remote server 132 over the Internet 134, may be copied directly onto the central server 102 or may be stored on the central server 102 by any other desired means. In the exemplary embodiment of FIG. 1, the updated operating software package 130 is transferred from the central server 102 to the terminal 106A over the network interface 104.

In order to automate the process of retrieving updated operating software, the central server 102 may suitably query the remote server 132 at suitable intervals to determine if updated operating software is available. Alternatively, the remote server 134 may send alerts to servers such as the server 102 which are part of systems that may retrieve and use operating software made available through the remote server 132. The systems to which alerts are sent may, for example, be systems for which an update subscription service has been established.

Once updated operating software is present on the central server 102, the central server may send an alert to the terminals 106A-106C so that the updated operating software package 130 can be retrieved. Details of the retrieval will be presented for the terminal 106A, but it will be recognized that a similar procedure may be followed for the terminals 106B and 106C and for any other terminals communicating with the central server 102 and associated with devices using onboard controllers that may employ updated operating software such as the operating software package 130.

Once the updated operating software package 130 has been stored on the terminal 106A, the terminal 106A transfers the updated operating software package 130 to the onboard controller 116 through the USB connection 112A. The FPGA 118, under the control of the operating software package 124, transfers the operating software package 128 to the flash memory 122. The transfer is managed by the USB communication control module 126 and the data transfer module 128, which are at this point residing in the FPGA 118 as part of the operating software package 124. The operating software package may overwrite the operating software package 124 in the flash memory 122, because the FPGA 118 is not being controlled by the operating software package 124 residing in the flash memory 122. Instead, the operating software package 124 has been loaded into, and resides in, the FPGA 118, and the data in the flash memory 122 does not affect the operation of the FPGA 118. Data in the flash memory 122 affects the operation of the FPGA 118 only when that data has been loaded into the FPGA 118.

As an alternative, or in addition, to providing the USB communication control module 126 and the data transfer module 128 as part of the operating software package 124, it is possible to include logic hardware in the FPGA 118 that accomplishes USB communication and data transfer. The presence of such logic hardware provides the FPGA 118 with an inherent capability to perform USB communication and data transfer, so that these capabilities will not be lost even in the event of a corruption of the programming of the FPGA 118 or the occurrence of an aborted transfer that removes the USB communication control module 126 and the data transfer module 122 before replacement modules have been stored in the flash memory 122.

Once the updated operating software package 130 has been copied into the flash memory 122, the transfer of the updated operating software package 130 to the onboard controller 116 is complete. The terminal 106A then directs a reset of the onboard controller 116. The updated operating software package 130 is transferred in parallel to the CPLD 120, where a serial conversion is performed and the updated operating software package 130 is serially loaded into the FPGA 118. The FPGA 118 then proceeds to operate under the control of the updated operating software package 130.

FIG. 1 illustrates the system 100 during the initial stages of the retrieval and loading of the updated operating software package 130. At this point, the operating software package 124 has been loaded into the FPGA 118, so that both the flash memory 122 and the FPGA 118 includes a copy of the operating software package 124, including the USB communication control module 126 and the data transfer module 128.

The updated operating software package 130 will be retrieved from the central server 102 by the terminal 106A for installation in the flash memory 122. At this point, the previously installed operating software package 124 is residing in the FPGA 118, and also remains in the flash memory 122. Installation of the updated operating software package 130 in the flash memory 122, and the subsequent loading of the updated operating software package 130 into the FPGA 118, is managed by the FPGA 118.

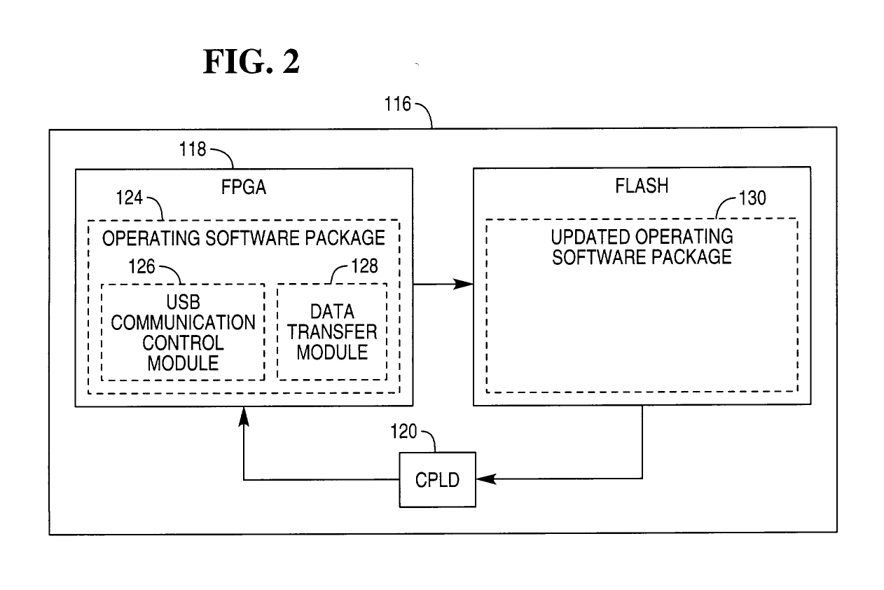

FIG. 2 illustrates the condition of the onboard controller 116 after the updated operating software package 130 has been loaded into the flash memory 122. At this point, the previously installed operating software package 124 is still residing in the FPGA 118, and can take actions needed in the functioning of the onboard controller 116. These actions include any actions necessary to load the updated software package 130 into the flash memory 122.

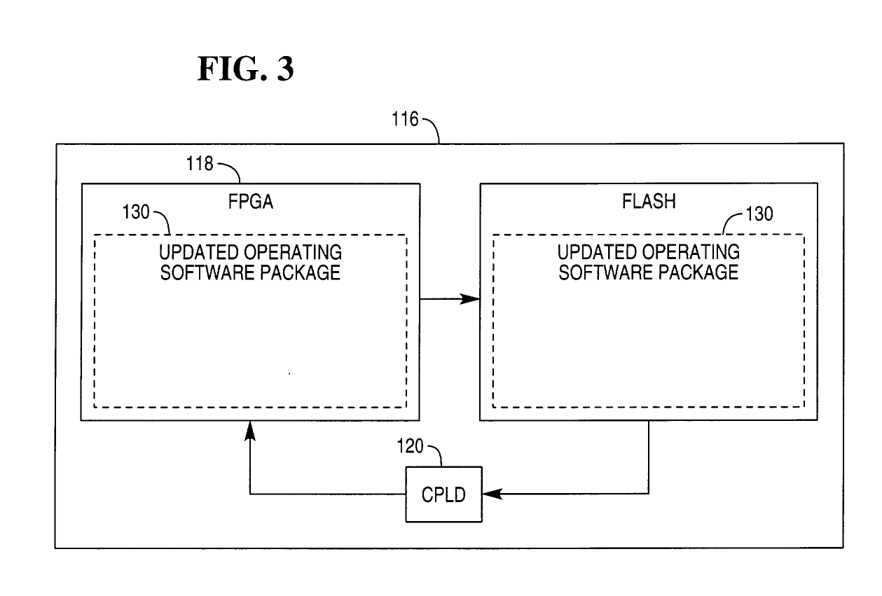

FIG. 3 illustrates the condition of the onboard controller 116 after the updated operating software package 130 has been completely loaded into the flash memory 122 and the onboard controller 116 has been reset so that the updated operating software package 130 has been loaded into the FPGA 118. It can be seen that the updated operating software package 130 is residing in the flash memory 122, and that a copy of the updated operating software package 130 is present in the FPGA 118. The previously installed operating software package 124 has been completely replaced.

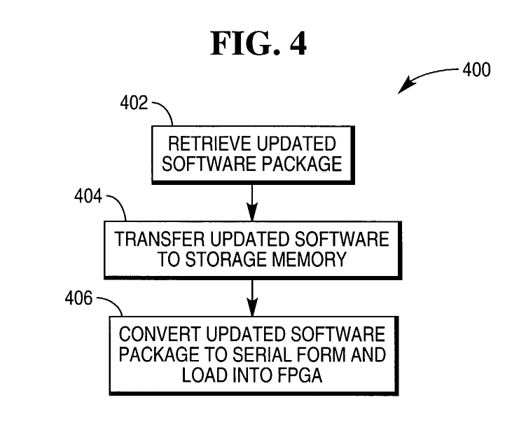

FIG. 4 illustrates the steps of a process 400 according to the present invention for remotely programming a field programmable gate array. At step 402, an updated operating software package is received by a terminal, typically by retrieving the updated operating software package from a central server, but alternatively by other means such as copying the updated operating software package from a floppy disk or CD-ROM. The central server and the terminal may be similar to the central server 102 and the terminal 106A of FIG. 1, and may be connected through a network connection similar to the network interface 104 of FIG. 1. The updated operating software package may suitably have been previously transferred to the central server from a remote location over an Internet connection. At step 404, the updated operating software package is transferred to a memory used to store operating software used by a field programmable gate array. The memory may suitably be a parallel flash memory similar to the flash memory of FIG. 122. The transfer may suitably be performed under control of the field programmable gate array, using a previously installed operating software package previously stored in the memory and loaded into the field programmable gate array from the memory. Transfer of the updated operating software package may suitably overwrite the previously installed operating software package in the memory.

At step 406, upon a reset or power up of the FPGA, the updated operating software package is converted to serial form and loaded into the FPGA. At this point, the previously installed operating software package has been overwritten and the updated operating software package is used to control the operation of the FPGA.

While the present invention is disclosed in the context of a presently preferred embodiment, it will be recognized that a wide variety of implementations may be employed by persons of ordinary skill in the art consistent with the above discussion and the claims which follow below.

I claim:

1. A device controller for controlling a device associated with the device controller, comprising:
a memory for storing operating software for the device controller;
a field programmable gate array for loading the operating software from the memory upon a power up or reset of the device controller and executing the operating software in order to control the device, the field programmable gate array being further operative to retrieve updated operating software from a location external to the device controller and store the updated operating software in the memory when it is desired to update the operating software for the device controller, the field programmable gate array being further operative to load the updated operating software from the memory in order to execute the updated operating software.

2. The device controller of claim 1, further comprising a complex programmable logic device for receiving parallel data from the memory and converting the parallel data to serial data for transfer to the field programmable gate array.

3. The device controller of claim 2, wherein the memory is a parallel flash memory.

4. The device controller of claim 3, wherein the field programmable gate array retrieves the updated operating software from a terminal connected to the device controller.

5. The device controller of claim 4, wherein the field programmable gate array retrieves the updated operating software over a universal serial bus connection between the terminal and the device controller.

6. A system for distributing updated operating software for device controllers, comprising:
a terminal operative to receive an updated software package and store the updated software package for retrieval by a device controller;
a peripheral device associated with the terminal, the peripheral device being controlled by a device controller operative to retrieve the updated operating software from the terminal, the device controller comprising a field programmable gate array for retrieving the updated operating software from the terminal and a memory for storing the updated operating software, the field programmable gate array being operative to retrieve the updated operating software from the terminal and store it in the memory, the field programmable gate array being further operative to load the updated operating software from the memory upon power up or reset of the device controller.

7. The system of claim 6, wherein the device controller also includes a complex parallel logic device for receiving parallel data from the memory and transferring the data to the field programmable gate array in serial format.

8. The system of claim 7, wherein the memory is parallel flash memory.

9. The system of claim 8, further including a central server for storing updated operating software to be distributed to the device controllers and wherein the terminal receives the updated operating software from the central server.

10. The system of claim 9, wherein the central server retrieves updated operating software from a remote server.

11. The system of claim 10, wherein the central server communicates with the remote server over the Internet.

12. The system of claim 11, wherein the central server notifies the terminal when updated operating software is available.

13. The system of claim 12, wherein the remote server notifies the central server when updated operating software is available.

14. A method of remote programming of a field programmable gate array, comprising:
transferring the updated operating software package to a memory accessible to the field programmable gate array; and
loading the updated operating software package to the field programmable gate array.

15. The method of claim 14, wherein the memory is a parallel memory and the updated operating software package is converted to serial form for transfer to the field programmable gate array.

16. The method of claim 15, wherein the step of transferring the updated software package to a memory accessible to the field programmable gate array is preceded by a step of receiving the updated operating software package at a terminal capable of communicating with the field programmable gate array.

17. The method of claim 16, wherein the step of receiving the updated operating software package at the terminal includes retrieving the updated operating software package from a central server.
